(19) United States
(12) Patent Application Publication
(10) Pub. No.: US 2025/0117174 A1
(43) Pub. Date: Apr. 10, 2025

(54) IMAGE DATA TRANSMISSION METHOD AND IMAGE PROCESSING MODULE

(71) Applicants: Cheng-Pin HUANG, Taipei City (TW); Chien-Wei YEH, Taipei City (TW)

(72) Inventors: Cheng-Pin HUANG, Taipei City (TW); Chien-Wei YEH, Taipei City (TW)

(21) Appl. No.: 18/731,241

(22) Filed: Jun. 1, 2024

Related U.S. Application Data
(60) Provisional application No. 63/471,768, filed on Jun. 8, 2023.

(51) Int. Cl. G06F 3/14; G06F 13/38; G06F 13/42; H04N 7/015

(52) U.S. Cl. CPC G06F 3/14; G06F 13/382; G06F 13/4282; H04N 7/015; G06F 2213/0042

(57) ABSTRACT

The present invention provides an image data transmission method and an image processing module. The image data transmission method comprises following steps: separating an image data into a first part and a second part by an image processing module; outputting the first part and the second part from a first connection port and a second connection port of an image processing module to a third connection port and a fourth connection port of a computer device; combining the first part and the second part by a software driver layer of the computer device to obtain combined data; and decoding the combined data by an application layer of the computer device to display the image data. Wherein the first connection port and the second connection port have the same transmission specification, and the first part and the second part have the same size in each frame of the image data.

### CROSS REFERENCE TO RELATED APPLICATION

The present application claims priority to U.S. provisional application Ser. No. 63/471,768 filed on Jun. 8, 2023, the entire content of which is incorporated by reference to this application.

### BACKGROUND OF THE INVENTION

### 1. Field of the Invention

The present invention pertains to an image data transmission method and an image processing module, more specifically to an image data transmission method and an image processing module using two connection ports.

### 2. Description of the Prior Art

Most electronic devices use universal serial bus (USB) ports for data transmission, and transmission bandwidths of the USB ports has made significant progress with technological advancements. From the early USB 1.0 and USB 2.0 ports with the transmission bandwidths of only tens to hundreds of Mbps, to the recent USB 3.2 Gen1 ports with the transmission bandwidth of 5 Gbps, allowing faster transmission of large files. However, with the development of video technology, people are looking forward to watch 4K or higher resolution videos. Smoothly transmitting high-resolution image data remains a challenge for the USB ports with the limited transmission bandwidth. For example, to transmit uncompressed 4K resolution image data, one USB 3.2 Gen1 port can only achieve a frame rate of 30 fps, which still does not meet the basic requirement of commonly accepted frame rates (e.g., 60 fps). Additionally, if a higher transmission bandwidth port is disposed in an electronic device to transmit 4K60 fps image data, the cost will be too high.

Therefore, the industry needs a new image data transmission method and a new image processing module that can transmit uncompressed high-resolution image data using cost-effective ports, and the frame rate of the high-resolution image data should also meet user expectations.

### SUMMARY OF THE INVENTION

The present invention provides an image data transmission method that can use lower transmission specification ports to transmit high-resolution and high-frame-rate image data, thereby avoiding the need to excessively pursue the transmission specifications of the ports, and further reducing costs.

The present invention provides an image data transmission method, comprising the following steps: separating an image data into a first part and a second part by an image processing module; outputting the first part from a first connection port of an image processing module to a third connection port of a computer device; outputting the second part from a second connection port of the image processing module to a fourth connection port of the computer device; combining the first part and the second part by a software driver layer of the computer device to obtain combined data; and decoding the combined data by an application layer of the computer device to display the image data. Wherein the first connection port and the second connection port have the same transmission specification, and the first part and the second part have the same size in each frame of the image data.

In some embodiments, when the first connection port transmits the first part of one frame of the image data, the second connection port can simultaneously transmit the second part of the same frame of the image data. Additionally, the first part is the left half of each frame of the image data, and the second part can be the right half of the same frame. Alternatively, the first part is the upper half of each frame of the image data, and the second part can be the lower half of the same frame. Furthermore, the image data transmission method can further comprise: temporarily storing the first part and the second part in a register of the image processing module; and outputting the first part and the second part from the register via the first connection port and the second connection port, respectively, by the image processing module. On the other hand, the image processing module can receive the image data via a high-definition multimedia interface connection port, and the first connection port and the second connection port can be universal serial bus connection ports.

The present invention provides an image processing module that can use lower transmission specification ports to transmit high-resolution and high-frame-rate image data, thereby avoiding the need to excessively pursue the transmission specifications of the ports, and further reducing costs.

The present invention provides an image processing module, wherein the image processing module comprises an image splitter, a register, a first connection port, and a second connection port. The image splitter is used to equally divide each frame of an image data into a first part and a second part. The register is electrically connected to the image splitter for storing the first part and the second part of the image data. The first connection port and the second connection port are electrically connected to the register. Wherein the first connection port transmits the first part of the image data, the second connection port simultaneously transmits the second part of the image data.

In some embodiments, the first part and the second part of each frame of the image data can be divided either horizontally or vertically. Additionally, the first connection port and the second connection port can have the same transmission specification. Furthermore, the image data can be transmitted to the image processing module via a high-definition multimedia interface connection port, and the first connection port and the second connection port can be universal serial bus connection ports.

The present invention provides an image data transmission method, comprising the following steps: separating an image data into a plurality of parts by an image processing module; outputting the plurality of parts from a first set of universal serial bus connection ports of the image processing module to a second set of universal serial bus connection ports of a computer device; combining the plurality of parts by a software driver layer of the computer device to obtain a combined data; and decoding the combined data by an application layer of the computer device to display the image data. Wherein the first set of universal serial bus connection ports and the second set of universal serial bus connection ports are connected one-to-one, and the plurality of parts have at least a first part and a second part, and the first part and the second part have the same size in each frame of the image data.

In some embodiments, when any of the first set of universal serial bus connection ports transmits the first part of one frame of the image data, another of the first set of universal serial bus connection ports can simultaneously transmit the second part of the same frame of the image data. Additionally, the first part can be the left half of each frame of the image data, and the second part can be the right half of the same frame. Alternatively, the first part can be the upper half of each frame of the image data, and the second part can be the lower half of the same frame. Furthermore, the image processing module can receive the image data via a high-definition multimedia interface connection port.

In some embodiments, the image data transmission method can further comprise: storing the first part and the second part in a register of the image processing module; and simultaneously outputting the first part and the second part from the register via any two of the first set of universal serial bus connection ports by the image processing module.

In summary, the image data transmission method and the image processing module provided by the present invention can first divide the large image data into two smaller parts, and then use lower transmission specification ports to transmit the divided parts. Thus, the present invention can use two lower transmission specification ports to transmit high-resolution and high-frame-rate image data, thereby avoiding the need to excessively pursue the transmission specifications of the ports, and further reducing costs.

### BRIEF DESCRIPTION OF THE APPENDED DRAWINGS

FIG. 1 illustrates a block diagram of a system applying an image data transmission method according to an embodiment of the present invention.

FIG. 2 illustrates a schematic diagram of a divided image data according to an embodiment of the present invention.

FIG. 3 illustrates a schematic diagram of the divided image data according to another embodiment of the present invention.

FIG. 4 illustrates a schematic diagram of software functions according to an embodiment of the present invention.

FIG. 5 illustrates a flowchart of the steps of the image data transmission method according to an embodiment of the present invention.

FIG. 6 illustrates a flowchart of the steps of the image data transmission method according to another embodiment of the present invention.

### DETAILED DESCRIPTION OF THE INVENTION

The features, targetions, and functions of the present invention are further disclosed below. However, it is only a few of the possible embodiments of the present invention, and the scope of the present invention is not limited thereto; that is, the equivalent changes and modifications done in accordance with the claims of the present invention will remain the subject of the present invention. Without departing from the spirit and scope of the invention, it should be considered as further enablement of the invention.

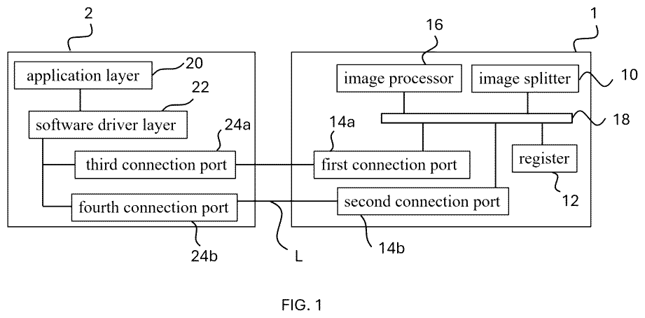

Refer to FIG. 1, which illustrates a block diagram of a system applying the image data transmission method according to an embodiment of the present invention. As shown in FIG. 1, the image data transmission method of the present invention is applied between an image processing module 1 and a computer device 2. The image processing module 1 may comprise an image splitter 10, a register 12, a first connection port 14a, a second connection port 14b, and an image processor 16. Additionally, the image processing module 1 has a bus 18, and the image splitter 10, the register 12, the first connection port 14a, the second connection port 14b, and the image processor 16 can be electrically connected through the bus 18 (e.g., AXI 128 bits bus). In one example, the image processing module 1 may also have an input port for an image data (not shown), which can be a high-definition multimedia interface (HDMI) port or other interfaces capable of transmitting image data. Of course, the image processing module 1 can also obtain the image data through other means, such as via the internet, and this embodiment is not limited to HDMI. Additionally, the image data can be an uncompressed video streams with 4K resolution and 60 fps frame rate, although the present invention can also be applied to video streams with other resolutions and frame rates.

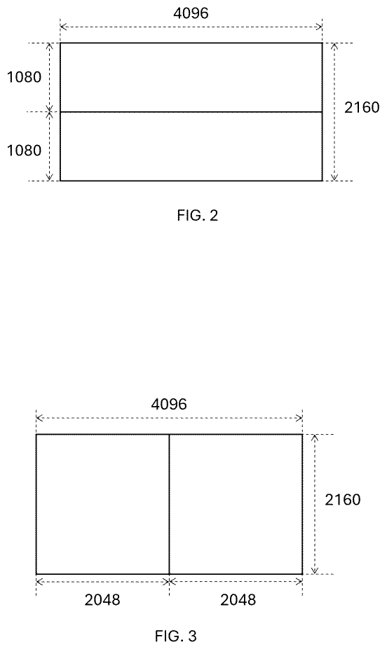

After receiving the image data, the image splitter 10 divides the image data into two equal parts (the first part and the second part). Specifically, when the image data is an video stream, it contains multiple frames, and the image splitter 10 divides each frame into two equal parts. In other words, the image splitter 10 sequentially divides each single frame of the image data into two halves, rather than dividing the image data into front and back halves. Additionally, the image splitter 10 is a hardware component, which is different from other software-based image data splitting means. Using the image splitter 10 to divide the image data can save system resources and be faster. For example, if the image data is an uncompressed 4K60 fps video stream, the image splitter 10 will divide each 4K frame into two equal-sized image blocks. Refer to FIG. 1 and FIG. 2 together, FIG. 2 illustrates a schematic diagram of the divided image data according to an embodiment of the present invention. As shown in the figures, if the resolution of one frame of the 4K image data is 4096×2160, the image splitter 10 can divide the 4K frame into an upper half (the first part) and a lower half (the second part) as shown in FIG. 2. At this time, the resolution of the upper half and the lower half is 4096×1080 each, and the first part and the second part have the same size, but correspond to different areas of the 4K frame.

This embodiment does not limit the image splitter 10 to divide the image data into upper and lower halves, the image data can also be divided into other types. Refer to FIG. 1 and FIG. 3 together, FIG. 3 illustrates a schematic diagram of the divided image data according to another embodiment of the present invention. Similarly, if the resolution of one frame of the 4K image data is 4096×2160, the image splitter 10 can also divide the 4K frame into a left half (the first part) and a right half (the second part) as shown in FIG. 3. At this time, the resolution of the left half and the right half is 2048×2160 each, and the first part and the second part have the same size, but correspond to different areas of the 4K frame. Of course, it is understood by person having ordinary skill in the art that the purpose of dividing the image data is to divide the 4K frame into smaller blocks with a smaller size. The image splitter 10 of this embodiment can also continue to divide the first part and the second part. For example, the image splitter 10 can further equally divide the left half and the right half of FIG. 3, making the 4K frame into four equal-sized image blocks (not shown), with a resolution of 2048×1080 or 1024×2160 each. In one example, the image splitter 10 can divide the input image data into two parts, and then repeatedly divide to obtain 2^{N} equal-sized image blocks, and this embodiment is not limited to this.

It is worth mentioning that the number of divisions of the image data by the image splitter 10 can be based on the number of connection ports of the image processing module 1, especially the number of connection ports of the image processing module 1 connected to the computer device 2. In other words, as shown in FIG. 1, only the first connection port 14a and the second connection port 14b of the image processing module 1 are connected to the computer device 2, so the image splitter 10 will divide the image data into two equal-sized image blocks (the first part and the second part). If the image processing module 1 finds that there are four connection ports connected to the computer device 2, the image splitter 10 can choose to divide the image data into two or four equal-sized image blocks, and this embodiment is not limited to this. Alternatively, if the image processing module 1 finds that there are three connection ports connected to the computer device 2, the image splitter 10 will still only divide the image data into two equal-sized image blocks and may not use all the connected ports to transmit the image data.

In practice, after the image splitter 10 divides the image data into the first part and the second part, the first part and the second part can be stored in the register 12, waiting for subsequent image processing or transmission. Additionally, when the image processing module 1 outputs the first part and the second part, the image processing module 1 will transmit the first part and the second part simultaneously, rather than sequentially. For example, the register 12 can be dynamic random-access memory (DRAM), and it is understood by person having ordinary skill in the art that the specifications of the register 12 can be related to memory storage specifications such as DDR3 for storing the first part and the second part. Generally, the image processing module 1 can also have the image processor 16, which can be used for general storage, transmission, or image processing tasks. In one example, the image processor 16 of the image splitter 10 can be integrated into a modular chip, and this embodiment will not be further elaborated here.

In one example, the first connection port 14a and the second connection port 14b can have the same transmission specifications, and the first connection port 14a and the second connection port 14b are respectively connected to the third connection port 24a and the fourth connection port 24b of the computer device 2 via transmission lines L. Here, the first connection port 14a and the second connection port 14b on the side of the image processing module 1 can be the first set of universal serial bus connection ports as referred to in the present invention. Additionally, the third connection port 24a and the fourth connection port 24b on the side of the computer device 2 can be the second set of universal serial bus connection ports as referred to in the present invention. For example, the first connection port 14a and the second connection port 14b of the image processing module 1 can both have the same transmission specifications, such as USB3.2 Gen1. It is understood by person having ordinary skill in the art that due to the limited transmission specifications (bandwidth) of USB3.2 Gen1, it can only transmit uncompressed 4K30 fps video streams. Therefore, if the original image data is an uncompressed 4K60 fps video stream, it cannot be transmitted in real-time using a single USB3.2 Gen1. However, since the image processing module 1 has already divided the original image data into two equal parts, the first part and the second part, each part should fit within the transmission specifications (bandwidth) of USB3.2 Gen1. In one example, the transmission lines L, the third connection port 24a, and the fourth connection port 24b of the computer device 2 must at least meet the USB3.2 Gen1 transmission specifications to receive the data transmitted by the first connection port 14a and the second connection port 14b of the image processing module 1 in real-time.

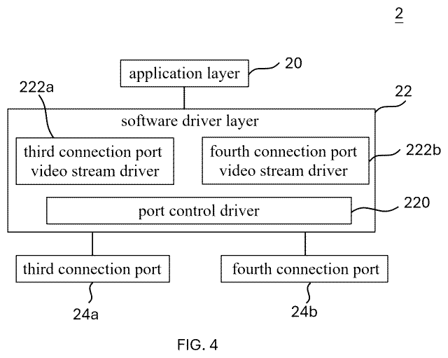

It is worth noting that the image processing module 1 of this embodiment transmits the first part and the second part simultaneously, rather than sequentially. In other words, when the third connection port 24a of the computer device 2 receives the first part, the fourth connection port 24b also receives the second part. For convenience of explanation, please refer to FIG. 1 and FIG. 4 together. FIG. 4 is a schematic diagram of software functions according to an embodiment of the present invention. As shown in the figures, in addition to the third connection port 24a and the fourth connection port 24b in hardware, the computer device 2 should also have corresponding drivers installed in a software driver layer 22 to obtain the received first part and second part in real-time and combine the first part and the second part back into the complete image data (which is referred as a combined data). Additionally, the computer device 2 should have a corresponding playback program installed in an application layer 20. After the software driver layer 22 obtains the combined data (the complete image data), the application layer 20 can decode the combined data to display the image data on the playback interface.

In practice, since the first part and the second part are sent simultaneously to the third connection port 24a and the fourth connection port 24b, a port control driver 220 of the computer device 2 should control the third connection port 24a and the fourth connection port 24b to receive the first part and the second part simultaneously. Additionally, at least one of a third connection port video stream driver 222a and a fourth connection port video stream driver 222b can be used to combine the first part and the second part. For example, when the third connection port video stream driver 222a is responsible for generating the combined data, the fourth connection port video stream driver 222b can provide the second part to the third connection port video stream driver 222a. Similarly, when the fourth connection port video stream driver 222b is responsible for generating the combined data, the third connection port video stream driver 222a can provide the first part to the fourth connection port video stream driver 222b. Then, after the software driver layer 22 obtains the combined data (the complete image data), it can temporarily store the combined data in the memory of the computer device 2 (not shown in the figure). The software driver layer 22 then fetches the combined data according to a fetch instruction of the application layer 20 (e.g., fetches the aforementioned uncompressed 4K60 fps video stream). In one example, the application layer 20 can be any third-party program used to play the uncompressed 4K60 fps video stream. In addition to having the function of decoding the combined data, the third-party program may also have the function of assisting in stitching images to be combined.

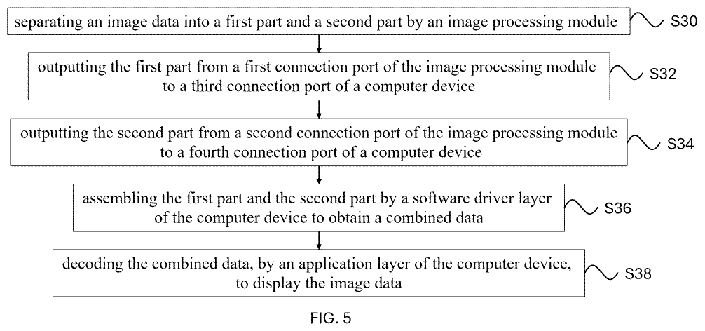

To facilitate the explanation of the image data transmission method of the present invention, please refer to FIG. 1 and FIG. 5 together. FIG. 5 is a flowchart of the steps of the image data transmission method according to an embodiment of the present invention. As shown in the figures, in step S30, the image data is divided into the first part and the second part by the image processing module 1. In step S32, the first part is output from the first connection port 14a of the image processing module 1 to the third connection port 24a of the computer device 2. In step S34, the second part is output from the second connection port 14b of the image processing module 1 to the fourth connection port 24b of the computer device 2. In step S36, the first part and the second part are combined by the software driver layer 22 of the computer device 2 to obtain a combined data. In step S38, the combined data is decoded by the application layer 20 of the computer device 2 to display the image data.

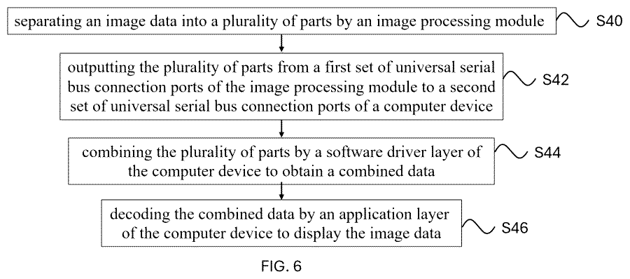

Additionally, the image data transmission method of the present invention can also be described from another perspective. Please refer to FIG. 1 and FIG. 6 together. FIG. 6 is a flowchart of the steps of the image data transmission method according to another embodiment of the present invention. As shown in the figures, in step S40, the image data is divided into multiple parts by the image processing module 1. In step S42, the parts are output from the first set of universal serial bus connection ports of the image processing module 1 to the second set of universal serial bus connection ports of the computer device 2. In step S44, the parts are combined by the software driver layer 22 of the computer device 2 to obtain a combined data. In step S46, the combined data is decoded by the application layer 20 of the computer device 2 to display the image data. The detailed description of the above method has been provided in the previous embodiments, and this embodiment will not be repeated here.

In summary, the image data transmission method and image processing module provided by the present invention can first divide the large image data into several smaller parts and then use lower transmission specification ports to transmit the divided parts. Thus, the present invention can use two lower transmission specification ports to transmit high-resolution and high-frame-rate image data, thereby avoiding the need to excessively pursue the transmission specifications of the ports, and further reducing costs.

What is claimed is:

1. An image data transmission method, comprising:
separating an image data into a first part and a second part by an image processing module;
outputting the first part from a first connection port of the image processing module to a third connection port of a computer device;
outputting the second part from a second connection port of the image processing module to a fourth connection port of a computer device;
assembling the first part and the second part by a software driver layer of the computer device to obtain a combined data; and
decoding the combined data, by an application layer of the computer device, to display the image data;
wherein the first connection port and the second connection port have the same transmission specification, and the first part and the second part have the same size in each frame of the image data.

2. The image data transmission method according to claim 1, wherein when the first connection port transmits the first part of one frame of the image data, the second connection port simultaneously transmits the second part of the same frame of the image data.

3. The image data transmission method according to claim 2, wherein the first part is the left half of each frame of the image data, and the second part is the right half of the same frame of the image data.

4. The image data transmission method according to claim 2, wherein the first part is the upper half of each frame of the image data, and the second part is the lower half of the same frame of the image data.

5. The image data transmission method according to claim 1, further comprising:
storing the first part and the second part in a register of the image processing module; and
outputting the first part and the second part from the register via the first connection port and the second connection port, respectively, by the image processing module.

6. The image data transmission method according to claim 1, wherein the image processing module receives the image data via a high-definition multimedia interface connection port.

7. The image data transmission method according to claim 1, wherein the first connection port and the second connection port are universal serial bus connection ports.

8. An image processing module, comprising:
an image splitter for equally dividing each frame of an image data into a first part and a second part;
a register, electrically connected to the image splitter, for storing the first part and the second part of the image data; and
a first connection port and a second connection port electrically connected to the register;
wherein when the first connection port transmits the first part of the image data, the second connection port simultaneously transmits the second part of the image data.

9. The image processing module according to claim 8, wherein the first part and the second part of each frame of the image data are separated either horizontally or vertically.

10. The image processing module according to claim 8, wherein the first connection port and the second connection port have the same transmission specifications.

11. The image processing module according to claim 8, wherein the image data is transmitted to the image processing module via a high-definition multimedia interface connection port.

12. The image processing module according to claim 8, wherein the first connection port and the second connection port are universal serial bus connection ports.

13. An image data transmission method, comprising:
separating an image data into a plurality of parts by an image processing module;
outputting the plurality of parts from a first set of universal serial bus connection ports of the image processing module to a second set of universal serial bus connection ports of a computer device;
combining the plurality of parts by a software driver layer of the computer device to obtain a combined data; and
decoding the combined data by an application layer of the computer device to display the image data;
wherein the first set of universal serial bus connection ports and the second set of universal serial bus connection ports are connected one-to-one;
wherein the plurality of parts have at least a first part and a second part, and the first part and the second part occupy the same size in each frame of the image data.

14. The image data transmission method according to claim 13, wherein when any of the first set of universal serial bus connection ports transmits the first part of one frame of the image data, another of the first set of universal serial bus connection ports simultaneously transmits the second part of the same frame of the image data.

15. The image data transmission method according to claim 14, wherein the first part is the left half of each frame of the image data, and the second part is the right half of the same frame of the image data.

16. The image data transmission method according to claim 14, wherein the first part is the upper half of each frame of the image data, and the second part is the lower half of the same frame of the image data.

17. The image data transmission method according to claim 13, further comprising:
storing the first part and the second part in a register of the image processing module; and
simultaneously outputting the first part and the second part from the register via any two of the first set of universal serial bus connection ports by the image processing module.

18. The image data transmission method according to claim 13, wherein the image processing module receives the image data via a high-definition multimedia interface connection port.
